(19) United States
(12) Patent Application Publication
(10) Pub. No.: US 2008/0091547 A1
(43) Pub. Date: Apr. 17, 2008

(54) SYSTEM FOR COLLABORATIVE REVIEWING AND RANKING OF PRODUCT CANDIDATES

(76) Inventor: Jeff Baker, Orlando, FL (US)

Correspondence Address: Beusse Wolter Sanks Mora & Maire, 390 N. ORANGE AVENUE, SUITE 2500, ORLANDO, FL, 32801, US

(21) Appl. No.: 11/537,126

(22) Filed: Sep. 29, 2006

(51) Int. Cl. G06Q 30/00

(52) U.S. Cl. 705/26

(57) ABSTRACT

Disclosed herein are systems and methods for the efficient, organized review and ranking of product candidates by a customer. The system and methods facilitate the easy collaboration of the provider and numerous personnel of customer involved in reviewing product candidates.

### BACKGROUND

In this age of e-commerce, businesses are always seeking new ways to conduct commerce through digital means via the internet. It is now commonly appreciated that the internet does provide a viable, powerful means for businesses to interact with customers. For businesses who sell tangible product, the basic model is relatively straightforward. Products can be displayed and customers can review and buy via digital means online. However, this model is not suitable for companies whose business involves a significant level of interaction and collaboration with its customers prior to a transaction involving a particular product. This is particularly true for businesses that sell customized products which are reviewed and selected by a team within the customer's entity.

### BRIEF DESCRIPTION OF THE DRAWINGS

FIG. 1 shows a block diagram of high level modules of an exemplary system embodiment.

FIG. 2 shows a diagram illustrating steps of a ranking process according to an exemplary method embodiment.

FIG. 3 shows a diagram of a provider website interface embodiment with functional options.

FIG. 4 shows a diagram of a provider website interface embodiment with functional options.

### DETAILED DESCRIPTION

The inventor has realized that there is a need for a system that facilitates the review and decision making process that involve the selection and purchase of customized products. The subject invention relates to methods, systems and products that facilitate the collaboration of business and customer in the development of customized products, which in turn leads to the transaction of products for which a customer has already developed a level of confidence. In one embodiment, the invention pertains to a product candidate review and ranking system comprising a provider computer unit and at least one customer computer unit. The provider computer unit comprises at least one processing module and at least one program code module provides webpage(s) having different functionality as will be described herein. Optionally, the provider computer comprises a program code module which functions to provide a web address which serves as a portal to one or more interconnected webpage(s). The webpage(s) display a plurality of potential product candidates predetermined by the business to be of interest to the customer. The webpage(s) also display a selectable ranking feature for each product. The provider computer comprises program code modules to execute different operational steps. Further, the customer computer unit may comprise program code modules to execute different operation steps, as will be further explained herein.

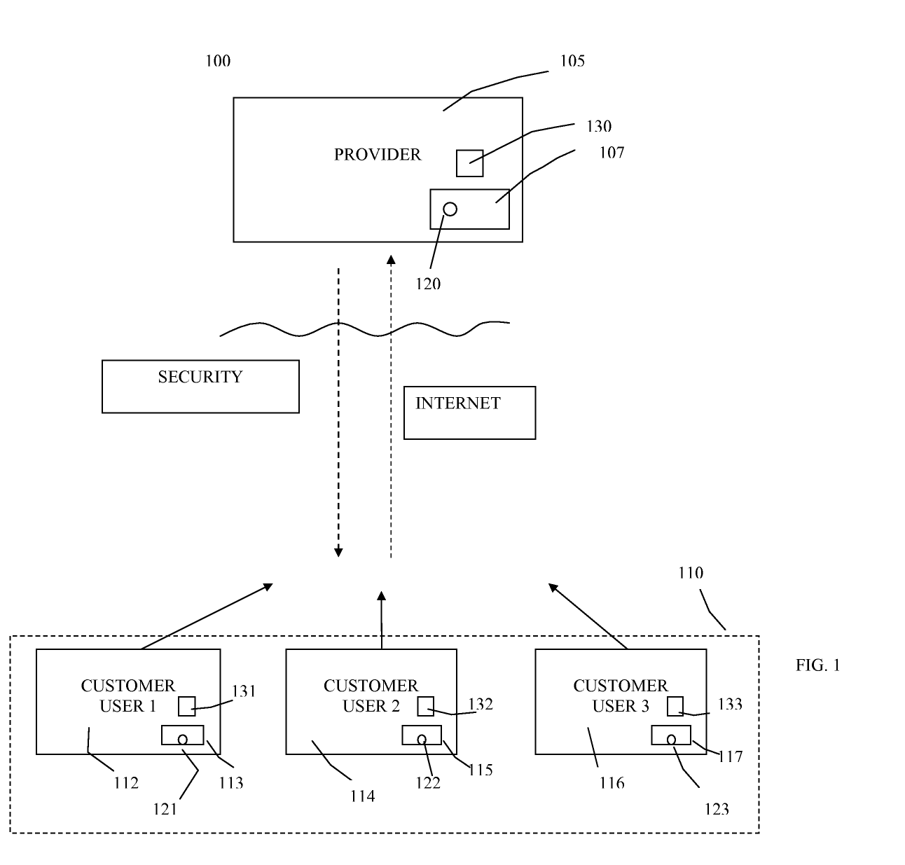

In one embodiment, as shown in FIG. 1, the subject invention relates to a system 100 of displaying and ranking prospective product candidates provided by a provider 105 to a customer 1 10. The provider 105 maintains a provider computer unit 107. The customer 110 comprises a number of users 112, 114, 116 each having customer user computer units 113, 115, 117 that interface with provider computer unit 107 via an internet connection. The interface with the provider computer unit 107 is protected by a security feature, including but not limited to, password protection or specific ip address connection (disclosed to user from provider), virtual private network, etc. Each computer unit comprises at least one processing module 120, 121, 122, and 123, respectively, for processing information. Furthermore, each computer unit is communicatingly connected to a display 130, 131, 132, and 133. Information and photos, or other visual representation directed to product candidates are stored on provider computer 107 which are conveyed to users 112, 114, 116 on customer computer units 113, 115, and 117 via a website interface as described in further detail below. The system allows the customer to better evaluate potential product candidates and determine which candidate(s) best suit their business needs.

The system facilitates a review by panel of multiple users such as sales and/or marketing personnel of the customer and can organize their input in an organized, efficient, cogent fashion. The system alleviates the need for disorganized and inefficient multiple communication between different personnel involved review and/or decision making of new products. Though the system is particularly useful for the review and decision-making associated with promotional product candidates it could be applied to other types of products including architectural design candidates, or building plan candidates, new business ideas, advertising campaigns, logo designs, or any other type of product where numerous candidates must be evaluated by numerous people.

As will be appreciated by one of skill in the art, embodiments of the present invention may be embodied as a device or system comprising a processing module, and/or computer program product comprising at least one program code module. Accordingly, the present invention may take the form of an entirely hardware embodiment or an embodiment combining software and hardware aspects. Furthermore, the present invention may include a computer program product on a computer-usable storage medium having computer-usable program code means embodied in the medium. Any suitable computer readable medium may be utilized including hard disks, CD-ROMs, DVDs, optical storage devices, or magnetic storage devices.

The term “processing module” may include a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The processing module may have operationally coupled thereto, or integrated therewith, a memory device. The memory device may be a single memory device or a plurality of memory devices. Such a memory device may be a read-only memory, random access memory, volatile memory, non-volatile memory, static memory, dynamic memory, flash memory, and/or any device that stores digital information. A computer, as used herein, is a device that comprises at least one processing module.

The computer-usable or computer-readable medium may be or include, for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM), a CD ROM, a DVD (digital video disk), or other electronic storage medium. Note that the computer-usable or computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

Computer program code for carrying out operations of certain embodiments of the present invention may be written in an object oriented and/or conventional procedural programming languages including, but not limited to, Java, Smalltalk, Perl, Python, Ruby, Lisp, PHP, “C”, FORTRAN, or C++. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Certain embodiments of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer-readable program code modules. These program code modules may be provided to a processing module of a general purpose computer, special purpose computer, embedded processor or other programmable data processing apparatus to produce a machine, such that the program code modules, which execute via the processing module of the computer or other programmable data processing apparatus, create means for implementing the functions specified in the flowchart and/or block diagram block or blocks.

These computer program code modules may also be stored in a computer-readable memory that can direct a computer or other programmable data processing apparatus to function in a particular manner, such that the program code modules stored in the computer-readable memory produce an article of manufacture.

The computer program code modules may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart and/or block diagram block or blocks.

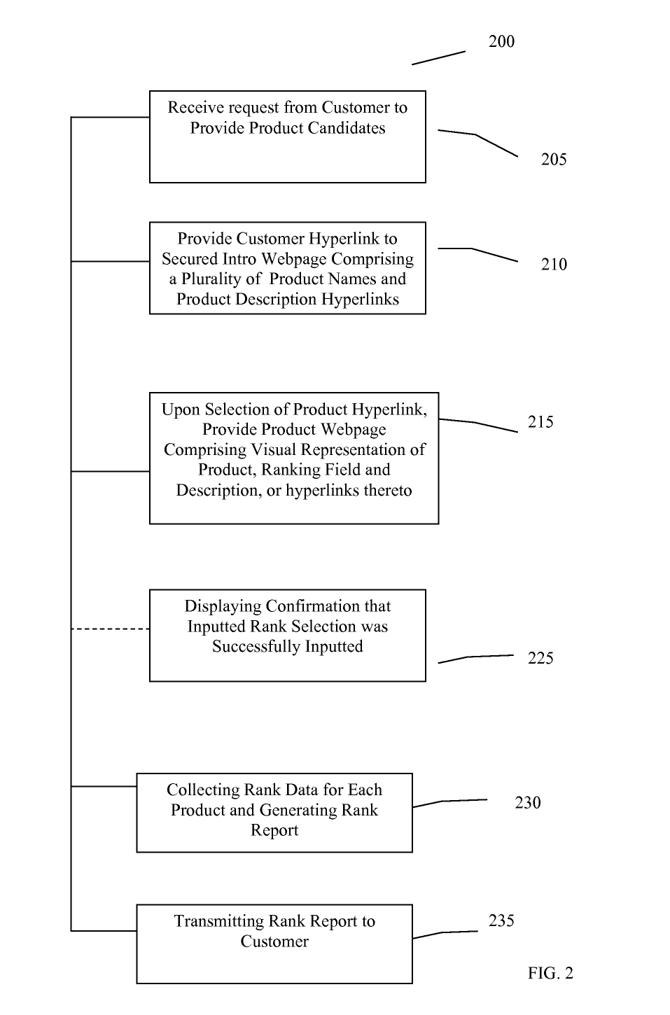

FIG. 2 shows a diagram 200 of an embodiment of the invention. As described above, operational steps may be executed by computer program code modules. For embodiment 200, program code modules execute operational steps entirely on a provider computer unit, or partly on a provider computer unit or entirely or partly on a customer/user computer unit. Furthermore, it is noted that ‘a computer unit’ may comprise one or more interconnected computer units. For example, a provider computer unit may be comprised of two or more interlinked computer units whereby operation steps are carried out on one or more than one of the interlinked computer units. The embodiment 200 comprises the step 205 of receiving request from Customer to Provide Product Candidates. Step 205 may or may not be an operational step executed by computer program code modules. The received request may take the form of an email, written request (mailed or faxed), verbal request. The request may be an indication of acceptance by customer to be provided with product candidates. Upon receiving request, the customer is provided a secured intro webpage interface that displays a plurality of product names and product hyperlinks, as in step 210. Note that the customer may comprise one or more users. Upon selection of product hyperlink, the customer is provided with a product webpage that comprises a visual representation of the selected product, a ranking field and/or product description, or hyperlinks thereto, as in step 215. The visual representation may take the form of artist rendering, graphical display and/or photograph. The ranking field may be a predetermined rank selection, or a space for inputting a predetermined numerical or alphabetical grade. Optionally, upon inputting a rank, a confirmation is provided to the customer, as in step 225. Steps 210, 215, and/or 225 may be repeated for other products listed on intro webpage. Ranking data for each product is collected and a rank data report is generated, as in step 230. The rank report may simply be a culling together of data in one report so as the rank of the respective product candidates can be determined. Typically, the rank report will specifically set forth the respective rank given for each product, and/or arrange the product names in an order from lowest to highest rank, or vice/versa. The rank report is transmitted to the customer, as in step 235. Transmission may take several forms, including, but not limited to, conventional mail, email, or posting on website.

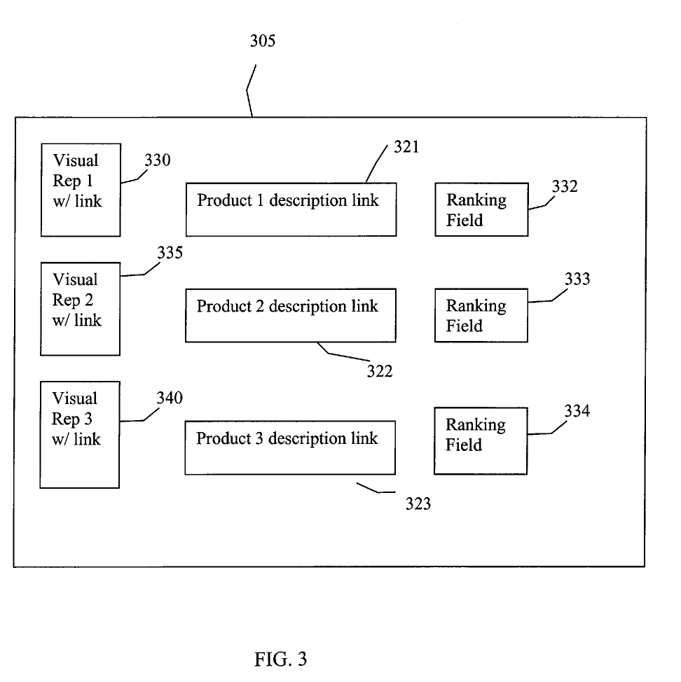

FIG. 3 shows a diagram of a provider website interface embodiment 305. For embodiment 305, the website interface is displayed on the one of the displays 130-133 (see FIG. 1). The interface 305 comprises a description hyperlink 321, 322, 323 which upon selecting actuates the display of a webpage interface that includes a full written description of the respective product candidate annotated on the hyperlink. Furthermore, the website interface 305 includes a visual representation of each respective product which also acts a selectable hyperlink to additional visual representations. The website interface embodiment 305 includes a ranking field 332, 333, 334 for each respective product candidate. The ranking field is configuring for inputting a rank for the respective product. This may comprise a selectable rank from a range such as 1-5, or 1-10, or may be a space for entry of a rank (predetermined numerical rank, grade, etc.).

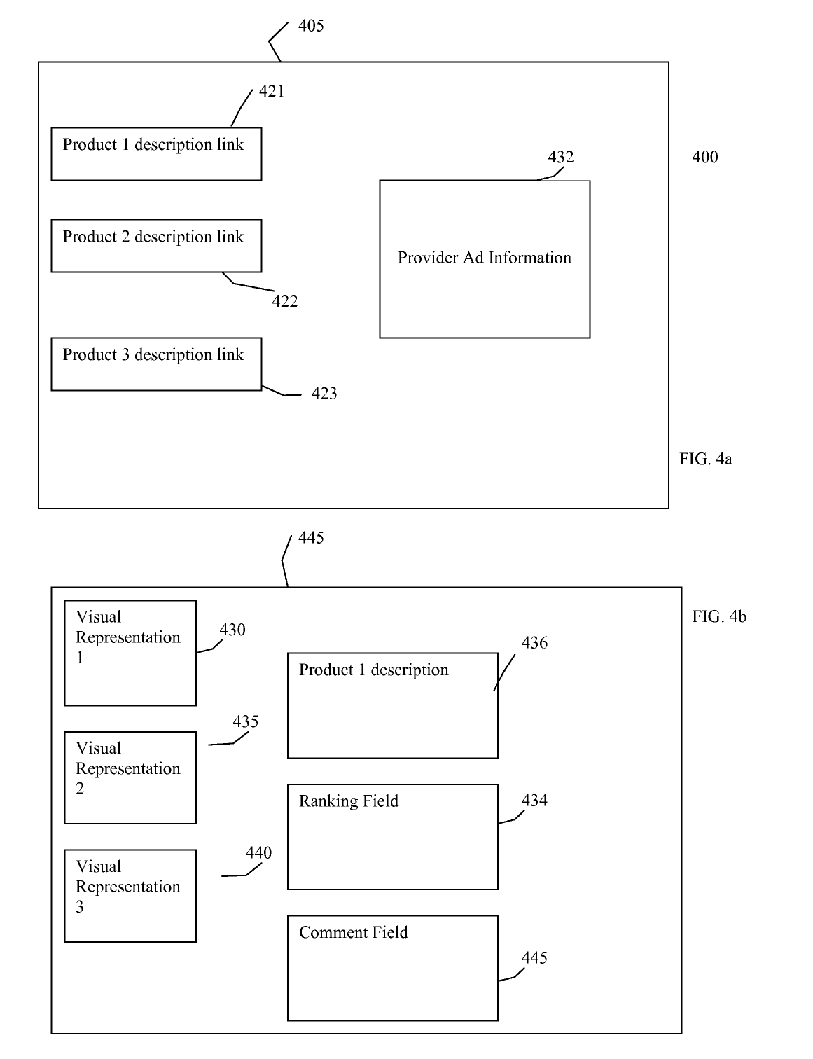

FIGS. 4a-b show a block diagram of another website interface embodiment 400 of the invention. The embodiment 400 comprises a first website interface 405 that comprises product description hyperlinks 421, 422, 423. The interface 405 also comprises a space onto which the Provider can place its own advertisement, with an optional link to the provider's own promotional website. Upon selecting one of the product hyperlinks 421, 422, 423, a product webpage is displayed on the user's display (see FIG. 1). FIG. 4b shows the product webpage 445 of product 1, which comprises a plurality of visual representations 430, 435 and 440 of the product candidate as well as a product description 436. Also included on the product webpage 445 is a ranking field 434 for inputting a rank for the product similar to that describe above for ranking fields 332, 333, 334. Furthermore, product webpage 445 comprises a comment field 445 so that user's can provide feedback pertaining to their opinion of the product. Alternatively, it is noted that the product description 436, ranking field 434, comment field 445, or visual representations 430, 435, 440 may be comprised of a hyperlink to another webpage where the webpage is configured to provide the similar function as if included on webpage 445.

The disclosures of the cited patent documents, publications and/or references are incorporated herein in their entirety to the extent not inconsistent with the teachings herein.

While a number of embodiments of the present invention have been shown and described herein in the present context, such embodiments are provided by way of example only, and not of limitation. Numerous variations, changes and substitutions will occur to those of skilled in the art without departing from the invention herein. For example, the present invention need not be limited to best mode disclosed herein, since other applications can equally benefit from the teachings of the present invention.

Accordingly, it is intended that the invention be limited only by the spirit and scope of the appended claims in accordance with relevant law as to their interpretation.

What is claimed is:

1. A product candidate review and ranking system comprising
a provider computer unit, said computer unit comprising at least one processing module and at least one memory device;
a plurality of customer user computer units and displays associated with each, wherein said provider computer unit and said plurality of customer user computer units are communicatingly connected;
a first program code module for causing a first webpage to be displayed on at least one of said displays, said first webpage comprising a plurality of product names and product description hyperlinks;
a second program code module for causing a second webpage to be displayed upon selection of product description hyperlink, said second webpage comprising at least one visual representation of a first product, or a hyperlink thereto, a ranking field, or hyperlink thereto; and a written description of said product description, or hyperlink thereto;
a third program code module for causing said provider computer unit to receive inputted ranking data; and
a fourth program code module for causing said provider computer unit to process inputted ranking data to determine respective ranks of product candidates;
wherein said first through seventh program code modules are loaded and executed entirely or partly on said provider computer unit or entirely or partly on at least one of said customer computer units.

2. The system of claim 1, wherein said ranking field comprises a plurality of predetermined ranks which are selectable by said user.

3. The system of claim 1, wherein said first webpage comprises written information about a provider, or hyperlink thereto.

4. The system of claim 1, further comprising a fifth program code module for causing a confirmation webpage to be displayed on at least one of said displays upon inputting of ranking data.

5. A computer program product for use with a provider computer unit communicatingly connected to a plurality of customer computer units each having a display associated therewith, said product comprising
a first program code module for causing a first webpage to be displayed on at least one of said displays, said first webpage comprising a plurality of product names and product description hyperlinks;
a second program code module for causing a second webpage to be displayed upon selection of product description hyperlink, said second webpage comprising at least one visual representation of a first product, or a hyperlink thereto, a ranking field, or hyperlink thereto; and a written description of said product description, or hyperlink thereto;
a third program code module for causing said provider computer unit to receive inputted ranking data; and
a fourth program code module for causing said provider computer unit to process inputted ranking data to determine respective ranks of product candidates;
wherein said first through seventh program code modules are loaded and executed entirely or partly on said provider computer unit or entirely or partly on at least one of said customer computer units.

6. A method of facilitating review of a plurality product candidates provided to a customer from a provider, said method comprising said provider conducting the following steps:
(a) receiving a request from said customer to provide product candidates;
(b) providing a secured first webpage to said customer, said first webpage comprising a plurality of product names and respective product description hyperlinks;
(c) upon selection of one of said product hyperlinks, providing a product webpage to said customer for the corresponding product, wherein said product webpage comprises at least one visual representation of the corresponding product, or a hyperlink thereto, a ranking field for the corresponding product, or hyperlink thereto, and a written description of the corresponding product, or a hyperlink thereto;
(d) upon inputting of rank, displaying a confirmation to said customer that rank was successfully inputted;
(e) collecting and processing of inputted rank data; and
(f) generating a rank report.

7. The method of claim 6, further comprising transmitting rank report to said customer.

8. The method of claim 6, further comprising repeating step (c) for each product of said plurality of product candidates.
